(19) United States
(12) Patent Application Publication
(10) Pub. No.: US 2009/0072084 A1
(43) Pub. Date: Mar. 19, 2009

(54) LIGHTER-THAN-AIR VEHICLES

(75) Inventor: Richard Hankinson, Elizabeth City, NC (US)

Correspondence Address: TROUTMAN SANDERS LLP, 600 PEACHTREE STREET , NE, ATLANTA, GA, 30308, US

(73) Assignee: Blackwater Airships, LLC, Elizabeth City, NC (US)

(21) Appl. No.: 12/234,315

(22) Filed: Sep. 19, 2008

Related U.S. Application Data
(60) Provisional application No. 60/973,655, filed on Sep. 19, 2007.

(51) Int. Cl. B64B 1/02

(52) U.S. Cl. 244/96; 244/62

(57) ABSTRACT

The present invention describes lighter-than-air vehicles. An exemplary embodiment of the present invention provides a lighter-than-air vehicle having a payload module, the payload module including an engine. Furthermore, the lighter-than-air vehicle includes a non-rigid envelope in communication with the payload module. The lighter-than-air vehicle also provides a propulsion system that includes a plurality of thrusters, the thrusters positioned substantially near the equatorial plane of the non-rigid envelope. In an alternative exemplary embodiment, the present invention provides a lighter-than-air vehicle comprising a payload module and a non-rigid envelope in communication with the payload module. Furthermore, the lighter-than-air vehicle includes a hydraulic propulsion system in communication with the non-rigid envelope and the payload module.

### CROSS REFERENCE TO RELATED APPLICATION

This application claims the benefit of U.S. Provisional Application No. 60/973,655, filed 19 Sep. 2007, which is hereby incorporated by reference in its entirety as if fully set forth below.

### FIELD OF THE INVENTION

The present invention relates generally to lighter-than-air vehicles and, more particularly, to lighter-than-air vehicles with improved propulsion systems.

### BACKGROUND OF THE INVENTION

Dirigibles, airships, and other types of lighter-than-air vehicles were some of the first vehicles to provide controlled, powered flight. Conventional lighter-than-air vehicles continue to be an effective and efficient vehicle for a variety of tactical missions and deployments. Generally, there are two main types of lighter-than-air vehicles: (1) non-rigid lighter-than-air vehicles, which typically use a pressure level in excess of the surrounding air pressure in order to retain their shape and often incorporate extended frames running along the bottom of the envelope for payload structures; and (2) rigid lighter-than-air vehicles, which have rigid frames throughout the envelope and often contain multiple, non-pressurized gas cells or balloons to provide lift. Conventional non-rigid lighter-than-air vehicles provide a lightweight structure with advantageous power efficiencies. A particular problem occurs with such non-rigid vehicles, however, because the lack of rigid structure within the envelope limits the placement of the thrust assemblies to the gondola or payload module of the vehicle. Thus, because the payload module is suspended from the bottom of the vehicle, any maneuvering forces generated by the propulsion system are not in desirable thrust vectors for the vehicle and, therefore, their effectiveness is reduced. Rigid lighter-than-air vehicles enable better maneuverability through efficient placement of the propulsion system as it can be attached at various points on the on the rigid frame, but the added weight of the frame significantly hinders the power efficiency of the vehicle.

Another major problem with both rigid and non-rigid lighter-than-air vehicles is their limited ability to hold a fixed position or station keep and/or maneuver when docking, especially if there are any significant cross-winds. This is due primarily to their large cross-sectional area, which causes the vehicle to “weather vane” and “wave” with the wind. They are particularly difficult to control if the wind is gusting or when there are significant up or down drafts. In fact, the ability to hold a substantially fixed position has proven to be very difficult portion for many conventional lighter-than-air-vehicles.

Therefore, it would be advantageous to provide a lighter-than-air vehicle capable of being both lightweight and highly maneuverable.

Additionally, it would be advantageous to provide a lighter-than-air vehicle with an improved propulsion system.

Additionally, it would be advantageous to provide lighter-than-air vehicle with a non-rigid envelope but with improved maneuverability and power efficiency.

### BRIEF SUMMARY OF THE INVENTION

The present invention describes lighter-than-air vehicles. An exemplary embodiment of the present invention provides a lighter-than-air vehicle having a payload module, the payload module including an engine. Furthermore, the lighter-than-air vehicle includes a non-rigid envelope in communication with the payload module. The lighter-than-air vehicle also provides a propulsion system that includes a plurality of thrusters, the thrusters positioned substantially near the equatorial plane of the non-rigid envelope.

In an alternative exemplary embodiment, the present invention provides a lighter-than-air vehicle comprising a payload module and a non-rigid envelope in communication with the payload module. Furthermore, the lighter-than-air vehicle includes a hydraulic propulsion system in communication with the non-rigid envelope and the payload module.

These and other objects, features and advantages of the present invention will become more apparent upon reading the following specification in conjunction with the accompanying drawing figures.

### BRIEF DESCRIPTION OF THE FIGURES

FIG. 1 provides multiple perspective views of a lighter-than-air vehicle 100 provided in accordance with an exemplary embodiment of the present invention.

FIG. 2 provides an illustration of the payload module 110 of a lighter-than-air vehicle 100 provided in accordance with an exemplary embodiment of the present invention.

FIG. 3 provides a schematic of the propulsion system 300 of a lighter-than-air vehicle 100 provided in accordance with an exemplary embodiment of the present invention.

### DETAILED DESCRIPTION OF PREFERRED EMBODIMENTS

The present invention addresses the deficiencies in the prior art concerning the inability of prior art airships to provide precision propulsion systems on lighter-than-air vehicles with non-rigid envelopes. The various features of the present invention improve the maneuverability and efficiency of the airship over conventional airship designs. Significantly, the present invention provides systems for providing effective lighter-than-air vehicles with non-rigid envelopes. A lighter-than-air vehicle provided in accordance with the present invention is enabled to provide a propulsion system with thrusters positioned substantially near the equatorial plane of the non-rigid envelope for improved maneuverability and power efficiency. Furthermore, a lighter-than-air vehicle provided in accordance with the present invention is enabled to operate with a hydraulic system.

In an exemplary embodiment, the present invention provides a lighter-than-air vehicle having a payload module, the payload module including an engine. Furthermore, the lighter-than-air vehicle includes a non-rigid envelope in communication with the payload module. The lighter-than-air vehicle also provides a propulsion system that includes a plurality of thrusters, the thrusters positioned substantially near the equatorial plane of the non-rigid envelope.

In an alternative exemplary embodiment, the present invention provides a lighter-than-air vehicle comprising a payload module and a non-rigid envelope in communication with the payload module. Furthermore, the lighter-than-air vehicle includes a hydraulic propulsion system in communication with the non-rigid envelope and the payload module.

In an exemplary embodiment, the lighter-than-air vehicle provides a novel hydraulic propulsion system that is dispersed about the lighter-than-air vehicle to enable the thrusters of the hydraulic propulsion system to be positioned on a non-rigid envelope or hull. More particularly, the lighter-than-air vehicle of the present invention relies upon a dispersed hydraulic propulsion system that is enabled to centralize power generation in the payload module of the vehicle, and then distribute that generated power to hydraulic motors mounted on the non-rigid envelope of the vehicle, where propulsion forces are more effective at maneuvering and propelling the lighter-than-air vehicle.

One of the significant advantages of the present invention is that it provides a lighter-than-air vehicle that does not require a rigid frame or structure for the envelope of the lighter-than-air vehicle. Conventional lighter-than-air vehicles typically require that either the thrusters of the propulsion system be attached to the payload module of the vehicle or that the envelope of the vehicle provide a rigid frame or structure to which the thrusters of the propulsion system can be mounted. The lighter-than-air vehicle provided in accordance with an exemplary embodiment of the present invention includes a non-rigid envelope with a collapsible structure, yet the vehicle still enables the thrusters of the propulsion system to be positioned substantially near the equatorial plane of the non-rigid envelope. The term equatorial is used herein to describe the centerline or longitudinal axis of the non-rigid envelope of the lighter-than-air vehicle. The phrase “substantially near the equatorial plane of the non-rigid envelope” is used herein to refer to a distance from the equatorial line of the non-rigid envelope not greater than 50% of the maximum radius of the non-rigid envelope. Therefore, the lighter-than-air vehicle provided in accordance with an exemplary embodiment of the present invention can provide the significant benefits of maneuverability, precision, control, and propulsion efficiency associated with thrusters positioned near the equatorial plane of the non-rigid envelope while at the same time providing a lighter-than-air vehicle with the collapsibility, compactness, ease of transport, and flexibility associated with a non-rigid envelope.

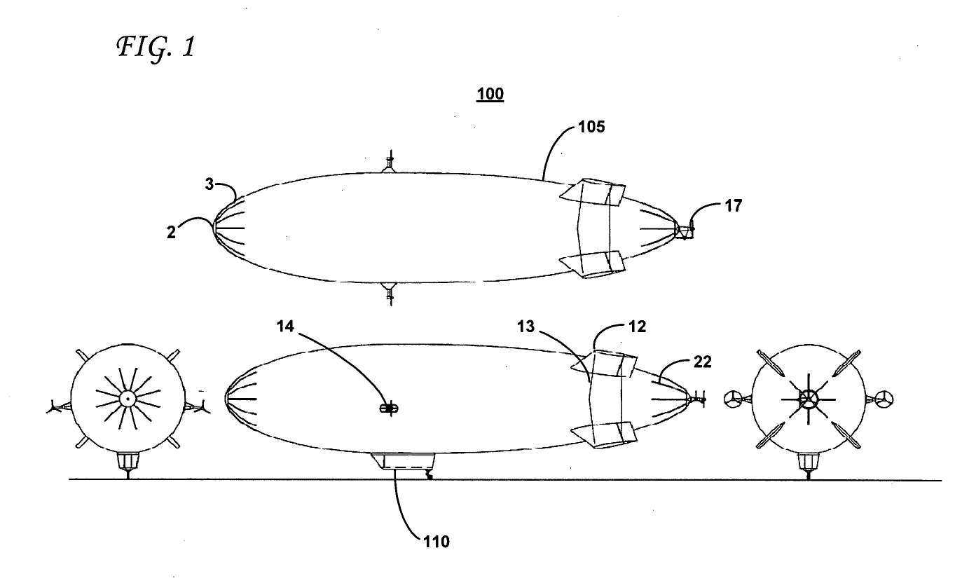

FIG. 1 provides multiple perspective views of a lighter-than-air vehicle 100 provided in accordance with an exemplary embodiment of the present invention. The exemplary embodiment of the lighter-than-air vehicle 100 shown in FIG. 1 includes a non-rigid envelope 105 and a payload module 110. The non-rigid envelope 105 of an exemplary embodiment of the lighter-than-air vehicle 100 can be configured in a modified ellipsoidal configuration with a high prismatic coefficient. In an exemplary embodiment, the non-rigid envelope 105 can be provided such that it is fully flexible and enabled to be collapsed into a compact state. Those of skill in the art will appreciate that the non-rigid envelope 105 can be configured in a variety of suitable configurations, including a combination of ellipsoidal shapes and modified ellipsoidal shapes.

The exemplary embodiment of the non-rigid envelope 105 of the lighter-than-air vehicle 100 shown in FIG. 1 includes a nose section that includes a nose cone 2, nose battens 3, a nose batten restraint patch, a nose batten pocket, and a forward handling line. In an exemplary embodiment, the nose cone 2 can be constructed from a welded alloy tube with provisions for the nose probe housing in the center and nose batten/flexible structure. In an exemplary embodiment, the nose cone 2 can include numerous nose battens 3 shaped to conform to the profile of the non-rigid envelope 105 and enabled to be mounted inside sleeving attached to the non-rigid envelope 105. The mid-section of the exemplary embodiment of the lighter-than-air vehicle 100 shown in FIG. 1 can include a helium valve, an anti collision light, ballonet top off, a ballonet air inlet port, and an air valve. The mid-section of the exemplary embodiment of the lighter-than-air vehicle 100 can also include a portion of the propulsion system 115. For example and not limitation, the mid section of the exemplary embodiment of can include a pylon 14 for a side thruster. Therefore, a side thruster can be mounted directly to the pylon 14 attached to the non-rigid envelope 105 in an exemplary embodiment of the lighter-than-air vehicle 100. The rear-section of the exemplary embodiment of the lighter-than-air vehicle 100 shown in FIG. 1 can include rear handling line, tail fins 12, tail fin restraint patches, tail fin suspension cables 18, tail fin suspension cable patches, and rear thruster battens 22. The rear-section of the exemplary embodiment of the lighter-than-air vehicle 100 can also include a portion of the propulsion system 115. As shown in the exemplary embodiment shown in FIG. 1, the rear-section can provide a rear thruster pylon 17 for a rear thruster.

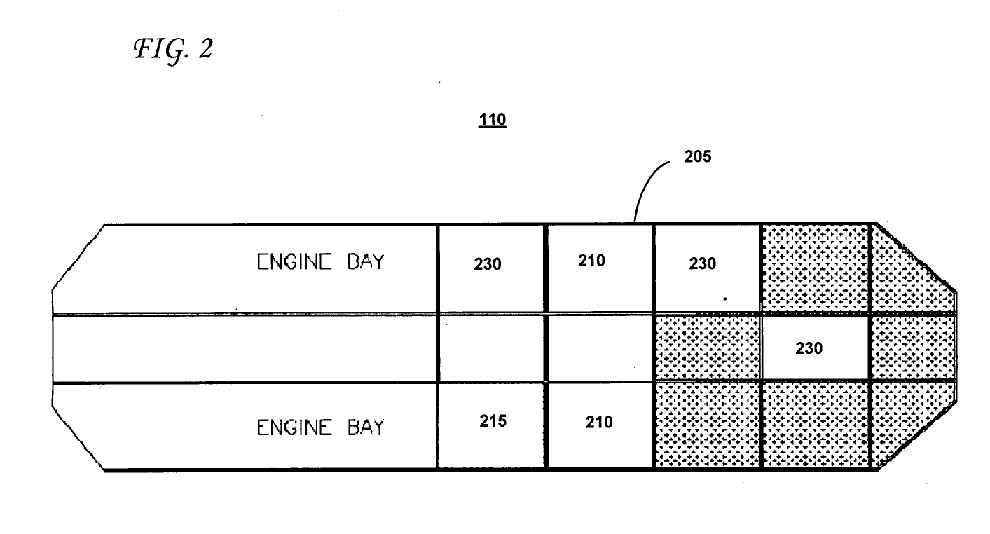

FIG. 2 provides an illustration of the payload module 110 of a lighter-than-air vehicle 100 provided in accordance with an exemplary embodiment of the present invention. The exemplary embodiment of the payload module 110 shown in FIG. 2 can be configured with a rigid frame 205 to house and support various components of the lighter-than-air vehicle 100. In an exemplary embodiment, the payload module 110 can be located on the lower surface of the non-rigid envelope 105 via steel bracing cables. In one embodiment, the payload module 110 can be configured with a double bottom floor comprising composite honeycomb sandwich floor paneling and floor paneling support structure attached to the main frame structure. In this embodiment, the centerline floor panels can be configured to be removable to provide access to the components in the payload module 110. In one embodiment, the rigid frame 205 can provide two main rails for support and structure that run longitudinally along the lighter-than-air vehicle 100. In another embodiment, the rigid frame 205 can be a light-weight latticed support structure. Those of skill in the art will appreciate that the rigid frame 205 can be configured in a variety of different ways according to the parameters of a particular embodiment.

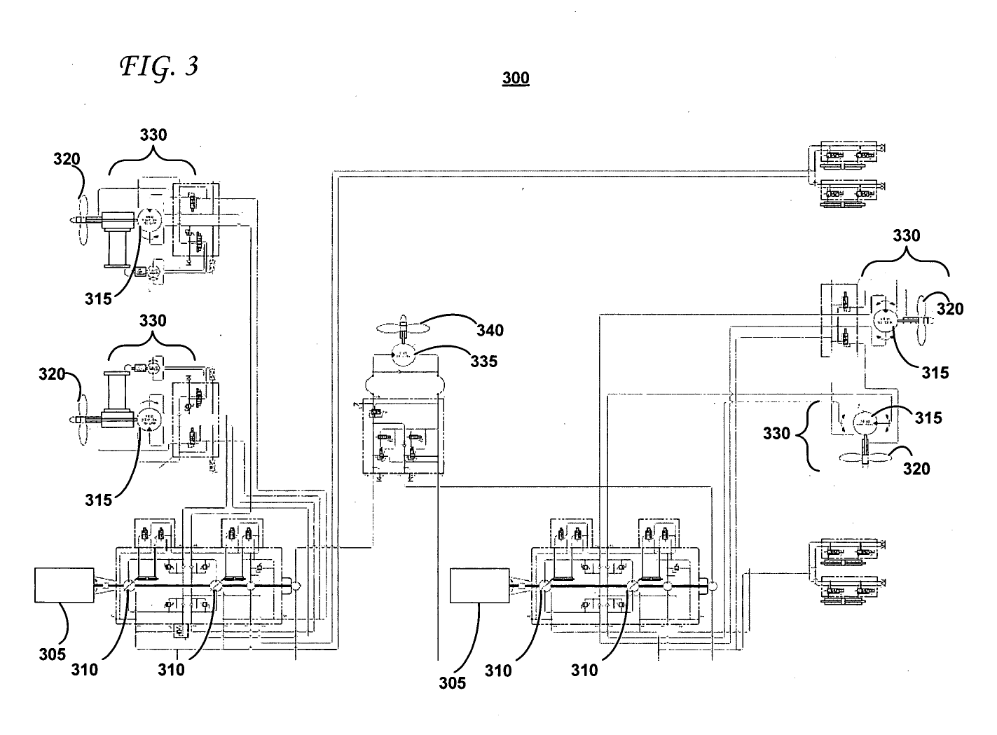

In an exemplary embodiment of the lighter-than-air vehicle 100, the rigid frame 205 of the payload module 110 can enable the heavier components of the lighter-than-air vehicle 100 to be housed in the payload module 110. The configuration of the heavier components of the lighter-than-air vehicle 100 in the payload module 110 provides a low center of gravity for the vehicle 100, which results in numerous benefits concerning the maneuverability and flight and landing characteristics of the vehicle 100. For example, and not limitation, the payload module 110, as shown in FIG. 2, can be configured to house the fuel tanks 210 and water ballast tanks 215 of the lighter-than-air vehicle 100. Furthermore, in the exemplary embodiment of the payload module 110 shown in FIG. 2, a section of the payload module 110 is configured to house the water recovery components and the power plant for the lighter-than-air vehicle 100. In exemplary embodiment, the power plant of the lighter-than-air vehicle 100 can provide energy to various devices aboard the lighter-than-air vehicle 100. Additionally, a section of the payload module 110 can be configured to house a portion of the propulsion system. In an exemplary embodiment, the payload module 110 can be configured to house the engine bay to include a portion of the propulsion system 300 (FIG. 3). The payload module 110 of an exemplary embodiment of the lighter-than-air vehicle 100 can be configured to providing an equipment bay 230. In an exemplary embodiment, the equipment bay 230 can provide a mission payload capacity, which enables storage of mission specific components for the lighter-than-air vehicle 100 including sensor packages, radar payloads, communications equipment, communication intelligence payloads, signal intelligence payloads or armaments.

The payload module 110 of the lighter-than-air vehicle 100 can be configured for a maximum mission payload capacity for depending upon embodiment of the lighter-than-air vehicle 100 and depending upon the goals a particular mission. For example, and not limitation, the maximum mission payload capacity of the equipment bay 230 of a first embodiment of the lighter-than-air vehicle 100 can be 500 pounds. For a second larger embodiment of the lighter-than-air vehicle 100, the maximum mission payload capacity can be 1000 pounds. In an exemplary embodiment the equipment bay 230 of the payload module 110 can be configured with a maximum mission payload capacity of 1000 pounds for a surveillance mission and be enabled to house and deploy a FLIR system (turret and master control) (˜223 lbs), a Synthetic Aperture Radar (˜135 lbs), a Phased Array Antenna and other antennas (˜125 lbs), an Electro Optical Camera (˜190 lbs), a Microwave Data Link & VHF/UHF Relay Repeater (˜60 lbs), and a Gyro Stabilization and Vibration Isolation System (˜205 lbs). Those of skill in the art will appreciate that the equipment bay 230 can be configured with a variety of devices to meet the requirements of a particular mission.

FIG. 3 provides a schematic of the propulsion system 300 of a lighter-than-air vehicle 100 provided in accordance with an exemplary embodiment of the present invention. One of the significant advantages of an exemplary embodiment of the lighter-than-air vehicle 100 is that can provide a propulsion system 300 that includes thrusters that can be positioned substantially along the equatorial plane of the non-rigid envelope 105. In an exemplary embodiment of the lighter-than-air vehicle 100, the propulsion system 300 can be a hydraulic based propulsion system comprising one or more engines, one or more hydraulic pumps, one or more hydraulic motors, and multiple propellers. Those of skill in the art will appreciate, as described in some of the embodiments below, that the hydraulic components described for the lighter-than-air vehicle 100 can be individually implemented in certain embodiments. For example, and not limitation, one embodiment of the lighter-than-air vehicle 100 may only use the hydraulic components for the lateral thruster and use conventional components for the propulsion system. Another embodiment of the lighter-than-air vehicle 100 may only use the hydraulic components for the ballonet system and conventional components for the other mechanisms.

In the exemplary embodiment of the propulsion system 300 depicted in FIG. 3, the propulsion system 300 includes two engines 305, four hydraulic pumps 310, four hydraulic motors 315, and four propellers 320. Those of skill in the art will appreciate that the components of the propulsion system 300 can vary without detracting from the scope of the invention, such as the number of engines, pumps, motors, and propellers can vary from implementation to implementation. For example, and not limitation, some embodiments may use one engine, while other embodiments may have an engine dedicated to each hydraulic pump in the system. Additionally, it may be advantageous to use multiple engines, pumps, and motors in an architecture to allow for redundancy in the system.

The engines 305 can be configured to each drive two hydraulic pumps 310, as shown in FIG. 3. In an exemplary embodiment of the propulsion system 300, the hydraulic pumps 310 can be a 55 cc Sauer-Danfoss Series 90 pump. In an exemplary embodiment, the first and second hydraulic pumps 310 can be located in line with the first engine 305 and can be connected directly to the first engine 305 crankshaft. Furthermore, in an exemplary embodiment, the third and fourth hydraulic pumps 310 can be located in line with the second engine 305 and can be connected directly to the second engine 305 crankshaft. In other contemplated embodiments of the propulsion system 300, fewer or more than four hydraulic pumps may be employed. In further contemplated embodiments of the propulsion system 300, the system 300 may employ other suitable pumps.

The torque generated by the engines 305 in an exemplary embodiment of the propulsion system 300 are converted into hydraulic pressure by the hydraulic pumps 310. Each of the hydraulic pumps 310 in an exemplary embodiment is preferably in fluid communication with one of the hydraulic motors 315 via flexible hydraulic tubing. The flexible tubing of an exemplary embodiment of the propulsion system 300 can be configured along the outer surface or inner surface of the non-rigid envelope 105. In an exemplary embodiment, the hydraulic motors 315 are a 75 cc Sauer-Danfoss Series 90 motor. As the two diesel engines 305 power the hydraulic pumps 310, hydraulic fluid pressure is translated to the hydraulic motors 315 through the tubing. The hydraulic motors 315 perform the opposite function of the hydraulic pumps 310, by converting hydraulic pressure into torque. In other embodiments of the propulsion system 300, the propulsion system 300 may employ other suitable motors.

To generate both forward, reverse, and lateral propulsion, the exemplary embodiment of the propulsion system 300 depicted in FIG. 3 relies upon four thrusters 330. Each thruster 330, in an exemplary embodiment, in comprised of a hydraulic motor 315 coupled to a propeller 320. The hydraulic motor 315 is powered by the hydraulic pressure delivered through tubing from the hydraulic pump 310 and is enabled to convert the hydraulic pressure into rotational energy engaged to rotate the propeller 320.

One of the significant advantages provided by the present invention is that the propulsion system 300 can be configured such that the thrusters 330 are directly mounted to the flexible non-rigid envelope 105 along the equatorial plane of the lighter-than-air vehicle 100. The exemplary embodiment of the propulsion system 300 shown in FIG. 3 enables placement along the equatorial plane of the non-rigid envelope 105 by requiring that only the thruster 330, including the hydraulic motor 315 and propeller 320, be mounted to the non-rigid envelope 105. Therefore, the thruster 330 can be configured to be sufficiently lightweight to enable a mount onto the flexible structure of an exemplary embodiment of the non-rigid envelope 105 without additional heavy support structures.

The ability to mount the thrusters 330 directly to the flexible non-rigid envelope 105 enables the thrusters to be placed in optimal positions about the lighter-than-air vehicle 100, depending upon the specific parameters of an embodiment of the lighter-than-air vehicle 100. In one exemplary embodiment, the first thruster 330 and the second thruster 330 can be configured at midship on each side of the envelope mounted on rigid pylon structures, such as pylon 14 shown in FIG. 1. The first midship thruster 330 preferably comprises the first hydraulic motor 315 coupled to a first propeller 320. The second midship thruster 330 preferably comprises the second hydraulic motor 315 coupled to a second propeller 320. The first and second hydraulic motors 315 are preferably in fluid communication with the first and second hydraulic pumps 310, respectively. The fluid pressure generated by the pumps 310 preferably causes the motors 315 to generate torque, as mentioned above. The torque generated by the first and second motors 315 in an exemplary embodiment preferably causes the propellers 320 to rotate, which generates thrust to maneuver and propel the lighter-than-air vehicle 100. Varying the RPMs of the diesel engines 305 or displacement of the hydraulic pumps 310 enables adjustment of the hydraulic fluid pressure and thus controls the rotational speed of the propellers 320. In this manner, the magnitude of the thrust generated by the propulsion system 300 can be regulated.

In an exemplary embodiment, the first and second thrusters 330 in the mid-section of the non-rigid envelope 105 are arranged to pivot about the axis of the vector tube center, to provide a vectorable thrust capability. Furthermore, in one embodiment, the thrusters 330 are controlled by a hydraulically operated Beta Coordinator and are each equipped with a reverse mode. Those of skill in the art will appreciate that various control and synchronization equipment can be used by the propulsion system 300.

An exemplary embodiment of the propulsion system 300 includes a vector system, which enables the first and second thrusters 330 to adjust the angle of the thrust in the pitch plane. In an exemplary embodiment, the vector system comprises vector motors, which enable rotation of the thrusters 330 via a self-locking spiroid bevel gear, allowing the propeller thrust to be diverted through 210 degrees: 120 degrees down to 90 degrees up. In other embodiments of the propulsion system 300, the angle of rotation of the thrusters may be modified. The vector motors in an exemplary embodiment can drive the spiroid bevel via an epicyclic reduction gearbox. In one embodiment, the vector motors are Samarium cobalt permanent magnet motors with radio suppression. By adjusting the angle of the thrust, the vector system can improve the lighter-than-air vehicle 100 maneuverability during take off and landing.

In an exemplary embodiment, the vector system of the lighter-than-air vehicle 100 includes an electrical synchronous system. This electrical synchronous system can couple two or more of the thrusters, such as the first and second thruster on opposite sides of the non-rigid envelope 105. In an exemplary embodiment, the electrical synchronous system can enable precisely synchronized control of the angle of both the first and second thrusters.

An exemplary embodiment of the lighter-than-air vehicle 100 is configured with pylons attached to the non-rigid envelope 105, such as pylon 14 shown in FIG. 1. In an exemplary embodiment, these pylons 14 can have a large structural footprint and can be coupled directly to the non-rigid envelope 105 of the lighter-than-air vehicle 100 without the need for internal support structures. The non-rigid envelope 105, in an exemplary embodiment, can be configured with reinforced material in the areas in which the thruster pylons 14 may be mounted. In a conventional design, the engine and propeller would require a heavy metal support structure within the envelope due to the relatively large weight of these components. In an exemplary embodiment of the present invention, the lightweight nature of the hydraulic motor enables the thrusters 330 to mount directly to the non-rigid envelope 105 of the lighter-than-air vehicle 100, without a support structure. Therefore, the present invention enables the removal of the heavy support structure from the envelope of the lighter-than-air vehicle; thus greatly reducing the overall weight of the lighter-than-air vehicle. The lighter-than-air vehicle 100 of the present invention relies upon a dispersed propulsion system 300 that is enabled to centralize power generation in the payload module 110 of the vehicle 100, and then distribute that generated power to locations on the non-rigid envelope 105 of the vehicle 100, where propulsion forces are more effective at maneuvering and propelling the lighter-than-air vehicle 100. Without rigid support structure, placement of thrust assemblies on conventional lighter-than-air vehicles with non-rigid envelopes is limited to the payload or gondola area.

In an exemplary embodiment, the propulsion system 300 further comprises a third forward and reverse thruster 330 located at the stern of the lighter-than-air vehicle on a rigid pylon 17 (see FIG. 1); also mounted within the pylon structure 17 is a fourth lateral thruster 330. The third thruster 330 can be configured to produce both forward and backward thrust. The third thruster 330 preferably comprises the third hydraulic motor 315 and propeller 320. The fourth lateral thruster 330 preferably comprises the fourth hydraulic motor 315 and propeller 320. In an exemplary embodiment, the third and fourth motors 315 are in fluid communication with the third and fourth hydraulic pumps 310 via tubing extending from the payload module 110 along the outer or inner surface of the non-rigid envelope 105 to the stem of the lighter-than-air vehicle 100. Similar to the first and second motors 315, the third and fourth motors 315 convert hydraulic pressure into torque for rotating the third and fourth propellers.

The third propeller 320 can be disposed substantially perpendicular to the axis of the non-rigid envelope 105 of the. This configuration enables the third propeller 320 to generate forward or backward thrust, depending on the pitch of the propeller blades, as discussed below. The fourth propeller 320 is preferably disposed traverse to the third propeller 320, and is operable to generate lateral thrust to assist in turning the lighter-than-air vehicle. In other contemplated embodiments of the present invention, the fourth propeller 320 may be replaced by a fan, ducted fan, ducted propeller, or other suitable propulsion means.

In an alternative embodiment of the lighter-than-air vehicle 100, the lateral thruster 330 is the only hydraulically powered thruster in the lighter-than-air vehicle 100. In this embodiment, the propulsion system is comprised of conventional components for the first, second, and third thrusters and the fourth lateral thruster 330 is the only hydraulic component in the system. In this alternative embodiment, fourth lateral thruster 330 can have a dedicated hydraulic pump and engine to provide the necessary hydraulic pressure to generate lateral thrust to steer the lighter-than-air vehicle 100.

In an exemplary embodiment of the lighter-than-air vehicle 100, the first, second, and third propellers 320 can each include variable hydraulic pitch control within the propeller hub. The pitch control in this exemplary embodiment enables the pitch of the propellers 320 to be adjusted. For example, and not limitation, the pitch of the propellers 320 can be adjusted in one embodiment of the pitch control between 20 and −25 degrees. In other contemplated embodiments of the present invention, the range of the pitch angle of the propellers 320 may be greater or smaller than the angles disclosed in this exemplary embodiment. In an exemplary embodiment, the lighter-than-air vehicle 100 can be configured such that the hydraulic supply for the pitch change device is the bleed off the hydraulic motor 315 supply return line, and does not require a separate power or hydraulic fluid pressure source. By adjusting the pitch of the propellers 320 in an exemplary embodiment, thrust can be regulated without changing the RPMs of the diesel engines 305 or the displacement of the hydraulic pumps 310.

The ability of an exemplary embodiment of the propulsion system 300 to adjusting forward thrust by varying propeller 320 pitch angle can enable configuring the thrusters 330 for efficient cruising and loitering. Further, the ability to achieve reverse pitch position with the propellers 320 in an exemplary embodiment of the propulsion system 300 enables backward thrust to be generated without changing the operational parameters of the hydraulic motors 310 or hydraulic pumps 315, which can improve maneuverability and assists in take off and landing control. Therefore, the hydraulic pitch control of an exemplary embodiment of the lighter-than-air vehicle 100 can provide substantially improved maneuverability over conventional designs.

The third thruster 330 and fourth lateral thruster 330 in an exemplary embodiment of the lighter-than-air vehicle 100 can comprise a thruster pylon, which contains both thrusters 330, coupled to a plurality of battens extending along the outer surface of the non-rigid envelope 105. In this exemplary embodiment, the battens can be coupled to the outer surface of the non-rigid envelope 105, but may also be implemented along the inside of the non-rigid envelope 105 if desired. The battens couple the thruster pylon, and consequently the third and fourth thrusters 330 themselves to the non-rigid envelope 105 of the lighter-than-air vehicle 100 in an exemplary embodiment. These battens in an exemplary embodiment can be tubular and constructed from a lightweight material. Contrary to an exemplary embodiment of the lighter-than-air vehicle 100 of the present invention, conventional airships with stem mounted propellers require heavy support structures to support the weight of the large motors needed to power the propellers. Therefore, the propulsion system 300 of an exemplary embodiment of the present invention provides substantially lighter stern mounted propulsion for an airship than conventional designs, thereby allowing a lighter overall airship design.

The first, second, and third thrusters 330 in an exemplary embodiment of the lighter-than-air vehicle 100 are each preferably disposed in the equatorial plane of the envelope of the lighter-than-air vehicle 100. This configuration provides an extremely efficient and stable distribution of thrusting forces. To attain this configuration, conventional designs must employ extensive heavy support structures within the hull of the airship to support the large motors, as discussed above. The lightweight hydraulic motors 310 of an exemplary embodiment of the lighter-than-air vehicle 100 enable the propulsion system 330 to distribute thrusters 330 substantially in the equatorial plane of the non-rigid envelope 105 by attaching the thruster 330 directly to the surface of the non-rigid envelope 105 or employing a lightweight batten structure, without the need for elaborate, heavy support structures which increase the weight of the airship.

To maintain an exemplary embodiment of the lighter-than-air vehicle 100 at a desired elevation, the weight of the lighter-than-air vehicle 100 can be closely regulated. One of the major variables in the weight of an airship is the decrease in weight due to fuel being consumed during operation. In an exemplary embodiment, the lighter-than-air vehicle 100 provides a water recovery system that can maintain the ballast of the vehicle 100 and compensate for the fuel being burned. The water recovery system providing in an exemplary embodiment of the lighter-than-air vehicle 100 can capture exhaust gas from the engines 305 and convert it into water via a heat exchange system. The water can be stored in two interconnected bag tanks (FIG. 2) within the payload module 110 of an exemplary embodiment of the lighter-than-air vehicle 100. In one embodiment, electrically actuated dump valves can be mounted within each tank for release of excess water. The water recovery system of an exemplary embodiment of the lighter-than-air vehicle 100 can enable the vehicle 100 to constantly generate its own ballast, which can be readily disposed of and regenerated as needed. Further, by converting the exhaust gases into water in an exemplary embodiment, the heat signature of the lighter-than-air vehicle is reduced, making it less vulnerable to heat-seeking missiles.

An exemplary embodiment of the lighter-than-air vehicle 100 is maintained aloft by its helium filled non-rigid envelope 105. The internal pressure of the helium can be regulated in an exemplary embodiment by varying the volume of air encapsulated within the ballonet of the non-rigid envelope 105. This can be accomplished by selectively inflating and deflating a ballonet within the non-rigid envelope 105 of the lighter-than-air vehicle 100.

The ballonet structure included an exemplary embodiment of the lighter-than-air vehicle 100 provides several advantages over conventional designs. The ballonet of an exemplary embodiment of the lighter-than-air vehicle 100 can be constructed from polyurethane with a permeability of less than 1.0 liters per square meter per 24 hours. The ballonet can be disposed in an exemplary embodiment within the non-rigid envelope 105 on the centerline and is air filled. The ballonet in this exemplary embodiment can extend over the top of the Pay Load Module (PLM) and comprise a port enabling communication between the inside of the ballonet and the PLM. Alternatively, the port may be located on the non-rigid envelope 105 and enable access to the ballonet from outside of the car. As shown in FIG. 3, in an exemplary embodiment the ballonet system can be pressurized by a hydraulic motor 335 and fan 340 in communication with the propulsion system 300. One of the significant advantages of the ballonet system of an exemplary embodiment of the lighter-than-air vehicle 100 is that it can greatly reduce the risk of debris entering the system. Conventional ballonet systems are typically pressurized by air scoops, which draw air from behind the propellers mounted on the payload module. These scoops are prone to be contaminated by dirt and other debris due to the location of the propellers and the scoops near the ground. In an exemplary embodiment, the ballonet system enables pressurization from hydraulic motor 335 and fan 340, which is relatively free of debris and therefore reduces the stress on the ballonet fabric and the increases the life cycle of the system.

In an exemplary embodiment of the lighter-than-air vehicle 100, the non-rigid envelope 105 includes two 20 inch valves in communication with the ballonet for regulating flow of air out of the ballonet. These valves can enable the ballonet to be deflated, changing the volume within the non-rigid envelope 105 occupied by the helium, thus regulating the pressure of the helium. Additional air can be added to the ballonet through a hydraulically driven fan fitted to a further port through the external ballonet skin.

Another advantage of the ballonet of the present invention is that it is removable from within the non-rigid envelope 105 of the lighter-than-air vehicle 100 without dismantling the non-rigid envelope 105 or any part of the lighter-than-air vehicle 100. In many conventional designs, the non-rigid envelope 105 must be deflated or partially disassembled in order to remove and replace the ballonet. This is inconvenient since the ballonet may need to be replaced with greater frequency than the non-rigid envelope 105. Therefore, the removable design of the ballonet enables more efficient repair and maintenance of the lighter-than-air vehicle 100.

Those of skill in the art will appreciate that the ballonet can be configured in a variety of different shapes and structures. For example, and not limitation, the ballonet could be a spherical shape in one exemplary embodiment and a hemispherical shape in another exemplary embodiment.

The lighter-than-air vehicle 100 of the present invention possesses many important advantages over conventional airship designs. The features and embodiments of the exemplary embodiment of the lighter-than-air vehicle 100 described above synergistically reduce the weight of the lighter-than-air vehicle, improve maneuverability, increase fuel efficiency, and facilitate transport and deployment of the lighter-than-air vehicle.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents. Additionally, the examples and specifications provided herein are intended to disclose exemplary embodiments of the present invention but are not intended to limit the scope of the invention. Therefore, other modifications or embodiments as may be suggested by the teachings herein are particularly reserved as they fall within the breadth and scope of the claims here appended.

What is claimed is:

1. A lighter-than-air vehicle comprising:
a payload module, the payload module including an engine;
a non-rigid envelope in communication with the payload module; and
a propulsion system that includes a plurality of thrusters, the thrusters positioned substantially near the equatorial plane of the non-rigid envelope.

2. The lighter-than-air vehicle of claim 1, wherein the propulsion system is a hydraulic propulsion system.

3. The lighter-than-air vehicle of claim 2, wherein the propulsion system is comprised of an engine, a hydraulic pump, and each of the plurality of thrusters is comprised of a hydraulic motor and a propeller.

4. The lighter-than-air vehicle of claim 3, wherein the hydraulic motor and propeller are mounted to the non-rigid envelope.

5. The lighter-than-air vehicle of claim 4, wherein the hydraulic motor and propeller are mounted to the non-rigid envelope with a pylon and a batten structure.

6. The lighter-than-air vehicle of claim 4, wherein the engine and the hydraulic pump are located in the payload module.

7. The lighter-than-air vehicle of claim 2, wherein the thruster includes variable hydraulic pitch control.

8. The lighter-than-air vehicle of claim 2, wherein the propulsion system further comprises a vector system enabled to adjust the angle of the thrust from the propeller.

9. The lighter-than-air vehicle of claim 8, wherein the vector system enables the propeller thrust to be diverted through at least 90 degrees of rotation.

10. A lighter-than-air vehicle comprising:
a payload module;
a non-rigid envelope in communication with the payload module; and
a hydraulic propulsion system in communication with the non-rigid envelope and the payload module.

11. The lighter-than-air vehicle of claim 10, wherein the hydraulic propulsion system comprises an engine, a hydraulic motor, a hydraulic pump, and a propeller.

12. The lighter-than-air vehicle of claim 10, wherein the hydraulic motor and the propeller are mounted on the non-rigid envelope.

13. The lighter-than-air vehicle of claim 10, wherein the engine and the hydraulic pump are mounted in the payload module and connected to the hydraulic motor via a series of tubing.

14. The lighter-than-air vehicle of claim 10, wherein the hydraulic motor and propeller are thrusters positioned substantially near the equatorial plane of the non-rigid envelope.

15. A lighter-than-air vehicle comprising:
a payload module, the payload module including an engine and a hydraulic pump;
an non-rigid envelope in communication with the payload module, the envelope comprising:
a hydraulic motor in communication with the hydraulic pump via a plurality of tubing;
a propeller in communication with the hydraulic motor.

16. The lighter-than-air vehicle of claim 15, wherein the hydraulic motor and the propeller are positioned substantially near the equatorial plane of the non-rigid envelope.

17. The lighter-than-air vehicle of claim 16, wherein the hydraulic motor and the propeller are mounted to non-rigid envelope.

18. The lighter-than-air vehicle of claim 17, wherein the hydraulic motor and the propeller are mounted to the non-rigid envelope with a pylon and a batten structure.

19. The lighter-than-air vehicle of claim 15, further comprising a water recovery system enabled to maintain the ballast.

20. The lighter-than-air vehicle of claim 15, further comprising a vector system enabled to adjust the angle of the thrust from the propeller.

21. A lighter-than-air vehicle comprising:
a payload module;
a non-rigid envelope in communication with the payload module; and
a hydraulic system.

22. The lighter-than-air vehicle of claim 21, wherein the hydraulic system includes an engine, a hydraulic pump, a hydraulic motor, and a propeller enabled to generate lateral thrust.

23. The lighter-than-air vehicle of claim 21, wherein the hydraulic system includes an engine, a hydraulic pump, a hydraulic motor, and a fan enabled to pressurize the ballonet system.
